(19) United States
(12) Patent Application Publication
(10) Pub. No.: US 2004/0255837 A1
(43) Pub. Date: Dec. 23, 2004

(54) Bird deterrent

(76) Inventor: Bruce Donoho, Mission Viejo, CA (US)

Correspondence Address: Rutan & Tucker LLP, Suite 1400, 611 Anton Blvd., Costa Mesa, CA, 92626, US

(21) Appl. No.: 10/464,712

(22) Filed: Jun. 17, 2003

(51) Int. Cl. A01M 29/00

(52) U.S. Cl. 116/22 A

(57) ABSTRACT

A bird deterrent comprises a flap that is mechanically coupled to a wire or other support structure using a connector having a ratcheted or other locking or biasing gripping mechanism. The flap can be any suitable size, shape, and configuration, provided it has a sufficiently large wind-catching surface, and is large enough to deter birds. Movement of the flap in the wind can be advantageously facilitated with a swivel. When used on power lines, both the flap and the connector should be made from an electrically insulating material. In preferred embodiments the ratcheted gripping mechanism permits only tightening and not loosening, and the surfaces that directly attach to the wire or other structure are concave and/or ribbed.

### BACKGROUND OF THE INVENTION

This invention relates to the field of bird deterrents.

### BACKGROUND

There is a persistent problem occasioned by the tendency of birds to run into or land on electrical power and other wires, support stays, and the like. The problem has been addressed over the years with only limited success.

U.S. Pat. No. 5,845,607 to Kastner et al. (1998) teaches the placement of wires near the surface of a body of water. The wires reportedly deter birds from landing on the water by virtue of their interference with the birds' landing and take-off. Additionally, the wires can be tightened sufficiently to interact with the wind to produce a deterrent whine. While the Kastner approach may be desirable in some instances, it is not generally applicable to dry land applications, locations with only minimal wind, or to power, telephone, or support wires that need to be protected from birds over long stretches.

U.S. Pat. No. 5,058,335 to Richter (1991) teaches the attachment of plastic fingers onto wires or cable-like structures. The fingers are designed to flex under the weight of a bird, and are intended to deter birds from landing thereon by providing an unstable landing site. As with the Kastner et al. devices, Richter contemplates that the plastic fingers will be visibly flexed by wind, vibration or movement of the protected wire or cable-like structure, and in that manner also deter birds from landing or attempting to land. Unfortunately, the Richter approach is largely only effective in the close vicinity of the fingers. The devices are therefore not cost-effective for long stretches of power, telephone or support lines.

U.S. Pat. No. 4,962,619 to Chatten (1990) teaches the use of wind-operated flaps to deter birds from landing or approaching a protected area. The flaps have the advantage of deterring birds over long stretches of power or other lines, as well as being able to deter birds from other structures such as power line support structures, buildings, railings, bridges, and so forth—provided the flaps are appropriately spaced along the protected area. A problem with Chatten devices, however, is that the flaps are held in position by crimping. Over time the crimping will eventually work its way loose due to wind, thermal expansion and contraction, pressure from formation of ice, and so forth. The problem is especially problematic when applying the devices to live electrical wires, because one often cannot get sufficiently close to the wire to always perfect the crimps.

What is needed is a bird deterrent that is effective when properly spaced along a wire or other protected area, and which has a very strong tendency to remain in position when installed under the type of conditions typically employed in power line and other in situ installations.

### SUMMARY OF INVENTION

The present invention provides devices and methods for deterring birds from a wire or other structure, in which a flap is mechanically coupled to the structure using a connector having a ratcheted gripping mechanism.

The flap can be any suitable size, shape, and configuration, provided it has a sufficiently large wind-catching surface, and is large enough to deter birds. Movement of the flap in the wind can be advantageously facilitated with a swivel. When used on power lines, both the flap and the connector should be made from an electrically insulating material. In preferred embodiments the ratcheted gripping mechanism permits only tightening and not loosening, and the surfaces that directly attach to the wire or other structure are concave and/or ribbed.

Various objects, features, aspects and advantages of the present invention will become more apparent from the following detailed description of preferred embodiments of the invention, along with the accompanying drawing, in which like items are represented by like numerals.

### BRIEF DESCRIPTION OF THE DRAWINGS

FIG. 1 is a perspective view of a bird deterrent comprising a flap and a connector, according to the inventive subject matter.

FIG. 2 is a cross section through the connector of FIG. 1 at AA, with the tightener 48 turned about 45 degrees from that shown in FIG. 1.

FIG. 3 is a perspective view of a plurality of bird deterrents affixed to a power line.

### DETAILED DESCRIPTION

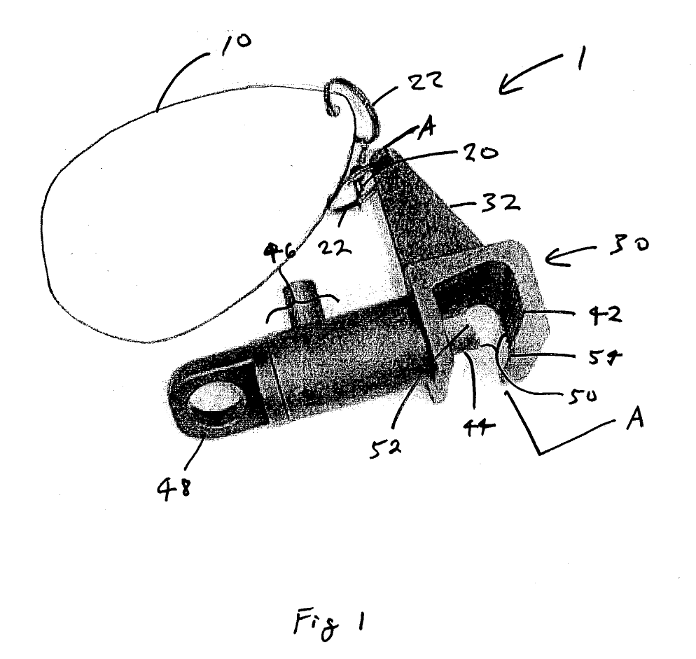

In FIG. 1 a bird deterrent 1 generally includes a flap 10, a swivel 20 and linkers 22, and a connector 30.

Flap 10 is a substantially flat piece of plastic. The preferred material is polyethylene although many other types of plastics, and indeed other materials can be used. For example, in some instances it may be desirable to use sheet metal, or even wood. The desirable characteristics are low cost, good workability, as well as resistance to repeated temperature changes, wind, rain, and so forth. In some instances aesthetics may be important, and it is helpful if a bright color, such as yellow, can be included in the material so that it doesn't war off. Flap 10 can be any suitable thickness, and need not be especially rigid.

Flap 10 has a tear drop shape, with two sides each having a surface area of approximately 900 cm². This particular shape is not especially important, and was chosen to avoid sharp corners that might be overly susceptible to damage, and for aesthetic reasons. The particular size is also not particularly important, and was chosen as a compromise among numerous factors, including convenience, customer expectations, expected effect on birds, aesthetics, and so forth. Other sizes of particular interest are sizes providing wind-catching surfaces of greater than 4 cm², greater than 6 cm², and greater than 8 cm². Of course, an infinite number of other combinations of shapes and sizes are also feasible, and may even be more efficient from a manufacturing and/or cost standpoint. For example, flaps could be made in lantern shapes, pagodas, spheres, cubes, cones, or any number of other configurations. It is even contemplated to employ multiple flaps with a single connector. In that case the flaps may or may not be the same size or shape as one another, and need not all connect to the connector in the same manner.

The surfaces of flap 10 can be any suitable color, pattern, and so forth. Bright yellow seems to be relatively effective for birds, but all other colors and color combinations are also contemplated. Moreover, flap 10 could be modified from a simply flat or shiny surface to including fluorescing surfaces, glow in the dark surfaces, and so on.

The swivel 20 and linkers 22 are all optional. They can be any suitable size, shape, and material. Here again, however, for electrical installations it may be desirable to employ insulating plastics, ceramics, or glass.

Connector 30 generally comprises a displacement arm 32, and a gripping mechanism 40 having a stop 42 and a finger 44, a ratchet 46, and a tightener 48.

In FIG. 1 the stop 42 and finger 44 have a maximum spacing of more than 3cm, and are capable of gripping a wide range of wires and other objects. This is facilitated by ribs 50 on the stop 42 and an end of the finger 44, and a concavity 52. The spacing is a design choice, and the ribs and concavity are optional. For example, the stop 42 could have its own concavity (not shown), and indeed stop 42 does have a lip 54 which can assist in holding a very large wire (not shown).

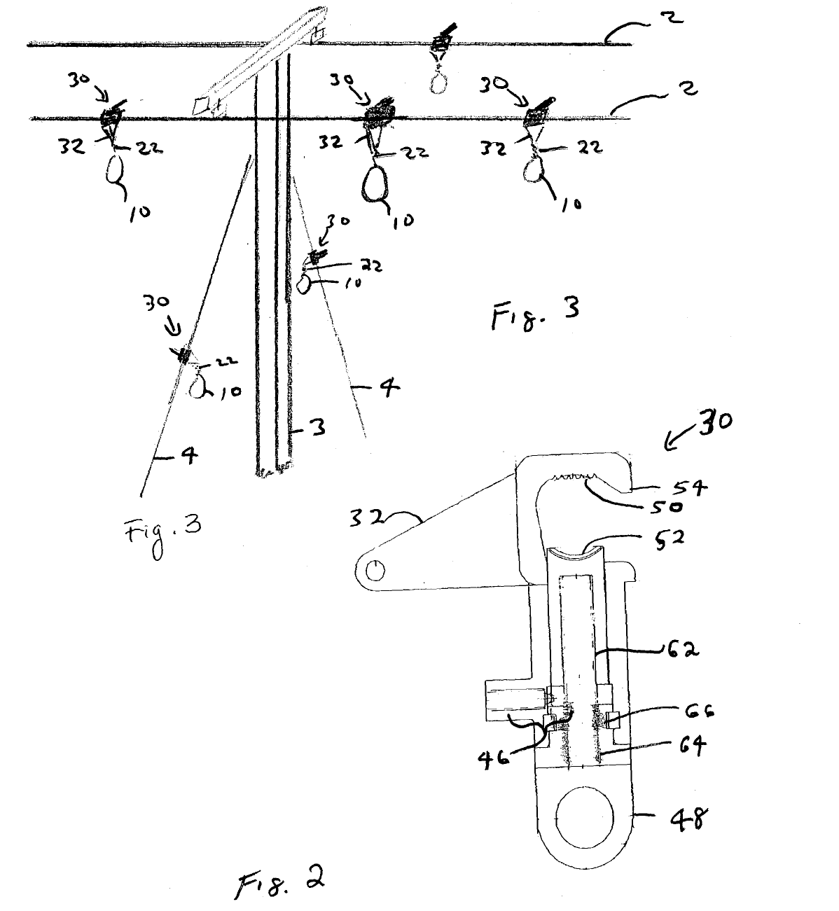

As best seen in FIG. 2, turning of the tightener 48 operates a bolt 62 having threads 64 that mate with threads 66 to force travel of the finger 46 towards the stop 42. The ratchet mechanism 46 operates in a manner not dissimilar to known ratchets. It is certainly advantageous that the ratchet mechanism allows travel of the finger 44 in one direction only, i.e. towards the stop 42. It is contemplated, however, that a user could be provided with an over-ride button (not shown) that would release the effect of the ratchet, and allow the finger 44 to withdraw away from the stop 42.

For the sake of simplicity of design, the tightener 48 is preferably located co-linearly with travel of the finger 44. This also allows the user (not shown) to tighten the connector 30 by operating the tightener 48 in an attitude that is normal to the wire, which can be a safety feature when working on live wires. The tightener 48 is shown as having an optional finger hole 49, which can be operated by a finger (not shown) or insulator stick (not shown).

It is contemplated that the connector could have a self-tightening mechanism other than, or in addition to a ratchet. For example, the finger could be biased against the wire or other structure by a spring, and the connector could be spring-loaded as sold, with a trigger that releases the spring. Spring loading is not preferred, however, because all springs suffer from fatigue over time, and may well have significantly reduced limited effectiveness when subjected to freezing conditions.

In FIG. 3 (not shown to scale) a plurality of bird deterrents 1 are shown in spaced disposition along power lines 2. Preferred spacing at least 3 meters apart, although greater and lesser spacings are also contemplated. It may also be desired to concentrate bird deterrents near support structures such as utility poles, where birds may be more likely to perch. It is thus contemplated that a method of protecting a power line (or indeed an entire grid) will be to place numerous bird deterrents along the power line(s). Depending on the spacing, it is entirely possible that over a distance of no more than one kilometer, a power line may have at least 10 bird deterrents as contemplated herein, more preferably at least 50 such bird deterrents, and even more preferably at least 100 such bird deterrents.

The same is true for stay wires. In FIG. 3, power lines 2 are supported by a wooden pole 3, which in turn is stayed by stay lines 4. Numerous bird deterrents 1 are disposed along the stay wires 4 as part of a method of protecting birds from accidentally running into the stay wires 4.

Thus, numerous devices and methods are disclosed herein for bird deterrents that include ratcheting or other locking or biasing gripping mechanisms. While specific embodiments and applications of this invention have been shown and described, it would be apparent to those skilled in the art that many more modifications are possible without departing from the inventive concepts herein. Among other things, for example, the concepts discussed herein can be employed in narrow access databases, such as those directed to employees or customers of a single company. The invention, therefore, is not to be restricted except in the spirit of the appended claims.

1. A bird-deterrent comprising a flap mechanically coupled to a connector having a rotatable ratcheted gripping mechanism.

2. The deterrent of claim 1 wherein the flap has a side having an area of at least 4 square centimeters.

3. The deterrent of claim 1 wherein the flap has a side having an area of at least 6 square centimeters.

4. The deterrent of claim 1 wherein the flap has a color other than white.

5. The deterrent of claim 1 wherein the flap has a shiny surface.

6. The deterrent of claim 1 wherein the flap comprises a fluorescing surface.

7. The deterrent of claim 1 wherein the connector comprises an electrically insulating plastic.

8. The deterrent of claim 1 wherein the ratcheted gripping mechanism permits only tightening and not loosening.

9. The deterrent of claim 1 wherein the ratcheted gripping mechanism includes a tightening loop positioned co-linearly with a travel of a finger towards a stop.

10. The deterrent of claim 1 wherein the ratcheted gripping mechanism includes a finger that travels towards a stop, said finger having a concavity at one end.

11. The deterrent of claim 1 wherein the ratcheted gripping mechanism includes a finger that travels towards a stop, said finger having a plurality of ribs at one end.

12. The deterrent of claim 1 wherein the flap is coupled to the connector via a swivel.

13. A power line having at least 50 bird deterrents according to claim 1 over a distance of no more than one kilometer.

14. A stay wire having at least 5 bird deterrents according to claim 1.
